(19) United States
(12) Patent Application Publication
(10) Pub. No.: US 2022/0314586 A1
(43) Pub. Date: Oct. 6, 2022

(54) HIGH GLOSS POLYMER FLOORING TILES

(71) Applicant: Welspun Flooring Limited, Mumbai (IN)

(72) Inventors: Dipali GOENKA, Mumbai (IN); Utpal HALDAR, Hyderabad (IN)

(73) Assignee: Welspun Flooring Limited, Mumbai (IN)

(21) Appl. No.: 17/573,308

(22) Filed: Jan. 11, 2022

(30) Foreign Application Priority Data
Mar. 31, 2021 (IN) 202121015286

(51) Int. Cl. B32B 27/08

(52) U.S. Cl. CPC B32B 27/08; B32B 2255/26; B32B 2255/10; B32B 2250/05; B32B 2419/04; B32B 2307/406; B32B 2305/30; B32B 2307/554

(57) ABSTRACT

This disclosure relates generally to composite polymer product applications. In one embodiment, a composite polymer flooring tile is disclosed, comprising: a core layer; a print layer applied to a surface of the core layer, the print layer including a decorative design; a wear layer applied to a surface of the print layer; a primer layer applied to a surface of the wear layer; a sanding layer applied to a surface of the primer layer, wherein the sanding layer includes a surface smoothened by sandblasting; an abrasive layer applied to the smoothened surface of the sanding layer, the abrasive layer including wear resistant particles; and a gloss layer applied to a surface of the abrasive layer; wherein a gloss level of the tile is at least 90% at 60° as measured according to ASTM D523 and EN 16094; and wherein the tile meets EPLF abrasion criteria (“AC”) rating of at least AC3.

### PRIORITY CLAIM

This U.S. patent application claims priority under 35 U.S.C. § 119 to: India Application No. 202121015286, filed Mar. 31, 2021. The entire contents of the aforementioned application are incorporated herein by reference.

### TECHNICAL FIELD

This disclosure relates generally to composite polymer product applications, and more particularly to high gloss polymer flooring tiles.

### BACKGROUND

The fabrication of composite polymer products has widespread industry applications, particularly for fabrication of flooring tiles. Composite polymer floor tiles usually comprise of a thermoplastic core, a thermoplastic print or decorative layer, a thermoplastic wear layer and a coating applied to the top surface of the wear layer. The thermoplastic core layer, thermoplastic print and thermoplastic wear layer may be then pressed together using heat and/or mechanical means to create the flooring tile. The composite polymer flooring tile may be cut to the desired size and a coating may be applied to the top surface of the thermoplastic wear layer. The coating is usually an acrylic lacquer or thermoplastic coating as well and undergoes a UV cure.

Polyvinyl chloride (PVC) is a common thermoplastic used in these types of composite polymer products, however the thermoplastic used for the core, print, and wear layers may be polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, methacrylate, and/or any combination thereof. Curing of the coating on the composite polymer floor tile helps achieve a uniform gloss level across the composite polymer floor tile.

The inventors here have recognized several technical problems with such conventional systems. For example, after conventional composite polymer floor tiles have been subject to use and wear, the coating and thermoplastic wear layer are easily worn down. Existing flooring products are also low gloss or medium gloss. Otherwise, flooring products with high gloss levels and/or mirror effect exhibit low performance characteristics and are thus unsuited for use as flooring products.

### SUMMARY

Embodiments of the present disclosure present technological improvements as solutions to one or more of the above-mentioned technical problems recognized by the inventors in conventional systems. For example, certain disclosed embodiments improve the durability of composite polymer floor tiles while improving the gloss level of the uppermost layer of the composite polymer floor tiles.

In one embodiment, a composite polymer flooring tile, is comprised of a core layer, a print layer applied to a surface of the core layer, the print layer including a decorative design, a wear layer applied to a surface of the print layer, a primer layer applied to a surface of the wear layer, an abrasive layer applied to the primer layer, the abrasive layer including wear resistant particles, a sanding layer applied to a surface of the abrasive layer, wherein the sanding layer includes a surface smoothened by sandblasting, and a gloss layer applied to a surface of the sanding layer, wherein a gloss level of the tile is at least 75% to 98% at 60° as measured according to ASTM D523, and wherein the tile meets EPLF abrasion criteria (“AC”) rating of at least AC3 to AC6 in Class 21 to 23 and 31 to 34.

In another embodiment, the composite polymer flooring tile further comprises a cushioning layer, wherein the core layer is applied to a surface of the cushioning layer.

In another embodiment, the cushioning layer comprises at least one of ethylene-vinyl acetate (EVA), irradiation cross-linked polyethylene (IXPE), or cork or any vinyl sheet.

In another embodiment, the cushioning layer has a thickness between 0.50-2.00 mm.

In another embodiment, the core layer comprises a thermoplastic material and a filler.

In another embodiment, the thermoplastic material comprised in the core layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate, high density polyethylene (HDPE), low density polyethylene (LDPE).

In another embodiment, the filler comprised in the core layer comprises at least one of calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, or internal lubricants.

In another embodiment, the core layer has a thickness between 1.00-8.00 mm.

In another embodiment, the print layer comprises a thermoplastic material.

In another embodiment, the thermoplastic material comprised in the print layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate, high density polyethylene (HDPE), low density polyethylene (LDPE).

In another embodiment, the print layer has a thickness between 0.07-0.10 mm.

In another embodiment, the wear layer comprises a thermoplastic material, a filler, and a plasticizer.

In another embodiment, the thermoplastic material comprised in the wear layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate, high density polyethylene (HDPE), low density polyethylene (LDPE).

In another embodiment, the filler comprised in the wear layer comprises at least one of calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, or internal lubricants.

In another embodiment, the plasticizer comprised in the wear layer comprises at least one of di-(2-ethylhexyl) phthalate, diisononyl phthalate, dibutyl phthalate, diisodecyl phthalate, di-n-octyl phthalate, benzyl butyl phthalate, isophthalic acid, terephthalic acid, alkyl esters of cyclohexane dicarboxylic acids, the dialkyl esters of aliphatic dicarboxylic acids, the alkyl esters of aromatic di-, tri-, or tetra-carboxylic acids, benzoates, citrates, phosphates, or sulfonates.

In another embodiment, the wear layer has a thickness between 0.10-0.70 mm.

In another embodiment, the primer layer comprises an acrylic lacquer.

In another embodiment, the acrylic lacquer comprised in the primer layer comprises a thermoplastic material.

In another embodiment, the thermoplastic material comprised in the primer layer comprises a UV curing acrylic based coating.

In another embodiment, the primer layer has a thickness between 0.001-0.050 mm.

In another embodiment, the sanding layer comprises an acrylic lacquer, sanding sealer, and particles.

In another embodiment, the acrylic lacquer comprised in the sanding layer comprises a thermoplastic material.

In another embodiment, the particles comprised in the sanding layer comprises at least one of aluminum oxide (AlOx), carborundum, quartz, glass beads, glass spheres, diamond particles, hard plastics, reinforced polymers, or organic particles.

In another embodiment, the sanding layer has a thickness between 0.001-0.050 mm.

In another embodiment, the abrasive layer comprises an acrylic lacquer.

In another embodiment, the acrylic lacquer comprised in the abrasive layer comprises a thermoplastic material.

In another embodiment, the thermoplastic material comprised in the acrylic lacquer comprises a UV curing acrylic based coating.

In another embodiment, the wear resistant particles included in the abrasive layer comprise at least one of aluminum oxide (AlOx), carborundum, quartz, glass beads, glass spheres, diamond particles, hard plastics, reinforced polymers, or organic particles.

In another embodiment, the abrasive layer has a thickness between 0.01-0.25 mm.

In another embodiment, the gloss layer comprises a UV lacquer and aluminum oxide.

In another embodiment, the UV lacquer comprised in the gloss layer comprises at least one of a two-component system, an epoxy amine, a polyurethane iscocyante, an isocyanate alcohol, an acid alcohol system, or a water-based two-component system.

In another embodiment, the gloss layer has a thickness between 0.01-0.25 mm.

In another embodiment, the composite polymer flooring tile meets EPLF AC rating of at least AC4.

In another embodiment, the composite polymer flooring tile meets EPLF AC rating of at least AC5.

In another embodiment, the composite polymer flooring tile meets EPLF AC rating of at least AC6.

In one embodiment, a composite polymer flooring tile, comprising a core layer, a print layer applied to a surface of the core layer, the print layer including a decorative design, a wear layer applied to a surface of the print layer, a primer layer applied to a surface of the wear layer, an abrasive layer applied to a surface of the primer layer, a sanding layer applied to the surface of the abrasive layer, wherein the sanding layer includes a surface smoothened by sandblasting, wherein a gloss level of the tile is at least 90% at 60° as measured according to ASTM D523 and EN 16094 testing methods, and wherein the tile meets EPLF abrasion criteria (“AC”) rating of at least AC3.

In another embodiment, the composite polymer flooring tile, further comprising a cushioning layer, wherein the core layer is applied to a surface of the cushioning layer.

In another embodiment, the cushioning layer comprises at least one of ethylene-vinyl acetate (EVA), irradiation cross-linked polyethylene (IXPE), or cork.

In another embodiment, the core layer comprises a thermoplastic material and a filler.

In another embodiment, the thermoplastic material comprised in the core layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate.

In another embodiment, the filler comprised in the core layer comprises at least one of calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, or internal lubricants.

In another embodiment, the core layer has a thickness between 1.00-8.00 mm.

In another embodiment, the print layer comprises a thermoplastic material.

In another embodiment, the thermoplastic material comprised in the print layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate.

In another embodiment, the print layer has a thickness between 0.07-0.01 mm.

In another embodiment, the wear layer comprises a thermoplastic material, a filler, and a plasticizer.

In another embodiment, the thermoplastic material comprised in the wear layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate.

In another embodiment, the filler comprised in the wear layer comprises at least one of calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, or internal lubricants.

In another embodiment, the plasticizer comprised in the wear layer comprises at least one of di-(2-ethylhexyl) phthalate, diisononyl phthalate, dibutyl phthalate, diisodecyl phthalate, di-n-octyl phthalate, benzyl butyl phthalate, isophthalic acid, terephthalic acid, alkyl esters of cyclohexane dicarboxylic acids, the dialkyl esters of aliphatic dicarboxylic acids, the alkyl esters of aromatic di-, tri-, or tetra-carboxylic acids, benzoates, citrates, phosphates, or sulfonates.

In another embodiment, the wear layer has a thickness between 0.10-0.70 mm.

In another embodiment, the primer layer comprises an acrylic lacquer.

In another embodiment, the acrylic lacquer comprised in the primer layer comprises a thermoplastic material.

In another embodiment, the thermoplastic material comprised in the primer layer comprises a UV curing poly urethane coating.

In another embodiment, the primer layer has a thickness between 0.001-0.050 mm.

In another embodiment, the sanding layer comprises an acrylic lacquer, sanding sealer, and particles.

In another embodiment, the acrylic lacquer comprised in the sanding layer comprises a thermoplastic material.

In another embodiment, the particles comprised in the sanding layer comprises at least one of aluminum oxide (AlOx), carborundum, quartz, glass beads, glass spheres, diamond particles, hard plastics, reinforced polymers, or organic particles.

In another embodiment, the abrasive layer has a thickness between 0.001-0.050 mm.

In another embodiment, the composite polymer flooring tile further comprises abrasive sanding layer applied to the smoothened surface of the abrasive layer, and wherein the sanding layer comprises an acrylic lacquer and wear resistant particles.

In another embodiment, the acrylic lacquer comprised in the abrasive layer comprises a thermoplastic material.

In another embodiment, the thermoplastic material comprised in the acrylic lacquer comprises a UV curing poly urethane coating.

In another embodiment, the wear resistant particles comprised in the abrasive layer comprise at least one of aluminum oxide (AlOx), carborundum, quartz, glass beads, glass spheres, diamond particles, hard plastics, reinforced polymers, or organic particles.

In another embodiment, the abrasive layer has a thickness between 0.01-0.25 mm.

In another embodiment, the composite polymer flooring tile further comprises a gloss layer applied to a surface of the abrasive layer, wherein the gloss layer comprises a UV lacquer.

In another embodiment, the UV lacquer comprised in the gloss layer comprises at least one of a two-component system, an epoxy amine, a polyurethane iscocyante, an isocyanate alcohol, an acid alcohol system, or a water-based two-component system.

In another embodiment, the gloss layer has a thickness between 0.01-0.25 mm.

In another embodiment, the composite polymer flooring tile meets EPLF AC rating of at least AC4.

In another embodiment, the composite polymer flooring tile meets EPLF AC rating of at least AC5.

In another embodiment, the composite polymer flooring tile meets EPLF AC rating of at least AC6.

In one embodiment, a method for manufacturing a composite polymer flooring tile, comprises creating a core layer, applying a cushioning layer below the core layer, applying a print layer to the core layer, applying a wear layer to the print layer, applying a primer layer to the wear layer, applying an abrasive layer to the primer layer, semi-curing the abrasive layer by UV lamp, applying a sanding layer to the abrasive layer, smoothing the sanding layer by sandpaper, curing the sanding layer by UV cure, applying a gloss layer to the sanding layer, applying a thermoplastic foil to the gloss layer, curing the gloss layer by UV cure.

In another embodiment, the core layer is produced by extrusion using a T mold with a conical extruder.

In another embodiment, the extruder used to produce the core layer comprises a conical, parallel counter rotating, or co-rotating extruder.

In another embodiment, the cushioning layer is applied to the core layer by hot rolling with a hot melt adhesive.

In another embodiment, the print layer is applied to the core layer by a method of pressing.

In another embodiment, the method of pressing comprises pressing using hot rollers of a hot press.

In another embodiment, the wear layer is applied to the print layer by a method of pressing.

In another embodiment, the method of pressing comprises pressing using hot rollers of a hot press.

In another embodiment, the sanding layer is smoothened by an abrasive blasting technique.

In another embodiment, the abrasive blasting technique comprises sand blasting the primer layer with a stream of abrasive materials under high pressure.

In another embodiment, the gloss layer is cured by applying a thermoplastic foil on a top surface of the gloss layer in a closed environment.

In another embodiment, the thermoplastic foil for curing the gloss layer is comprised of at least one of polyethylene terephthalate (PET), polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate.

In another embodiment, the method for manufacturing a composite polymer flooring tile, further comprises de-touching the cure on the gloss layer by removing the thermoplastic foil from the gloss layer.

In another embodiment, the primer layer is applied to the wear layer by passing through a UV light chamber.

In one embodiment, the composite polymer flooring tile has an Impact Insulation Class (IIC) rating between 50 and above.

In one embodiment, the composite polymer flooring tile has an Impact Insulation Class (IIC) rating between 50 and above.

In one embodiment, the method for manufacturing a composite polymer flooring tile comprises the sanding layer undergoing smoothening by sand paper after undergoing full cure.

In one embodiment, the method for manufacturing a composite polymer flooring tile comprises the composite polymer flooring tile undergoing cutting and profiling.

In one embodiment, the method for manufacturing a composite polymer flooring tile comprises the composite polymer flooring tile undergoing packaging after cutting and profiling.

In one embodiment, the method for manufacturing a composite polymer flooring tile comprises the cushion layer is applied to the print layer after the polymer flooring tile undergoes cutting and profiling but before packaging.

In one embodiment, the sanding layer is smoothened by sandpaper.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a schematic diagram of an example high gloss hard flooring tile according to some embodiments of the present disclosure.

FIG. 2 illustrates a schematic diagram of an example high gloss hard flooring tile with a cushion layer in accordance with some embodiments of the present disclosure.

FIG. 3 is a flow diagram illustrating an example method for manufacturing a flooring tile in accordance with some embodiments of the present disclosure.

FIG. 4 is a flow diagram illustrating an example method for manufacturing a flooring tile with a cushion in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

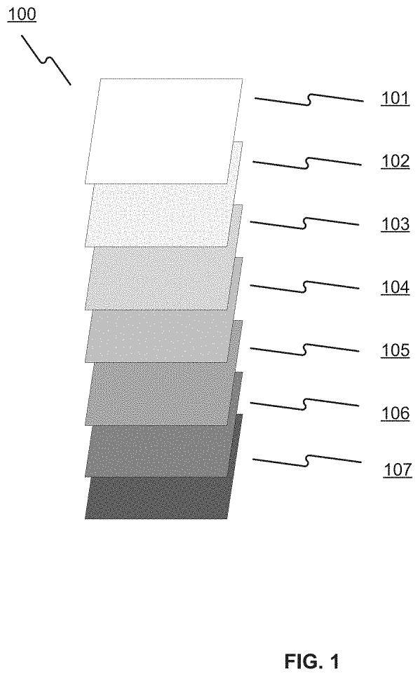

FIG. 1 shows a schematic diagram of an embodiment of a high gloss polymer hard flooring tile 100. A core layer 107 of variable thickness may be provided. A print layer 106 of variable thickness may be applied on the top surface of core layer 107 by hot lamination. Optionally, a wear layer 105 of variable thickness may be applied on the top surface of print layer 106 by hot lamination. Optionally, a primer layer 104 of variable thickness may be applied on the top surface of wear layer 105 by a coating device. Optionally, an abrasive layer 103 of variable thickness may be applied on the top surface of primer layer 104 by a coating device. Optionally, a sanding layer 102 of variable thickness may be applied to the top surface of the abrasive layer 103 by a coating device. A gloss layer 101 of variable thickness may be applied on the top surface of the abrasive layer 102 by UV curing.

In FIG. 1, core layer 107 may comprise a thermoplastic material and fillers, or any other type or polymer core comprising fillers and a thermoplastic material. For example, the thermoplastic material may be polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, methacrylate, high density polyethylene (HDPE), low density polyethylene (LDPE), and/or any combination thereof. The fillers may be calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, internal lubricants and/or a combination thereof. In a preferred embodiment, the thickness of core layer 107 may be about 1.00-8.00 mm.

In FIG. 1, print layer 106 may comprise a thermoplastic material. For example, the thermoplastic material may be polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, methacrylate, high density polyethylene (HDPE), low density polyethylene (LDPE), and/or any combination thereof. The print layer may include a decorative design. In a preferred embodiment, the thickness of print layer 106 may be about 0.07-0.01 mm.

In FIG. 1, wear layer 105 may comprise a thermoplastic material, a filler, plasticizer, and/or a combination thereof. For example, the thermoplastic material may be polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, methacrylate, high density polyethylene (HDPE), low density polyethylene (LDPE), and/or any combination thereof. Further, for example, the filler may be calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, internal lubricants, and/or any combination thereof. Moreover, for example, the plasticizer may be phthalate based or phthalate-free plasticizers and/or any combination thereof. For example, the phthalate-based plasticizer may be phthalic acid esters such as di-(2-ethylhexyl) phthalate, diisononyl phthalate, dibutyl phthalate, diisodecyl phthalate, di-n-octyl phthalate, benzyl butyl phthalate, isophthalic acid, terephthalic acid and/or any combination thereof. For example, the phthalate-free plasticizers may be alkyl esters of cyclohexane dicarboxylic acids, the dialkyl esters of aliphatic dicarboxylic acids, the alkyl esters of aromatic di-, tri-, or tetra-carboxylic acids, except for orthophthalic acid, benzoates, citrates, phosphates, sulfonates, and/or any combination thereof. In a preferred embodiment, the thickness of wear layer 105 may be about 0.10-0.70 mm.

In FIG. 1, primer layer 104 may comprise acrylic lacquer. The acrylic lacquer may comprise a thermoplastic material such as a UV curing acrylic based coating. In a preferred embodiment, the thickness of primer layer 104 may be about 0.001-0.050 mm.

In FIG. 1, abrasive layer 103 may comprise acrylic lacquer and wear resistant particles. For example, the acrylic lacquer may comprise a thermoplastic material such as a UV curing acrylic based coating. Further, for example, the wear resistant particles may comprise aluminum oxide (AlOx), carborundum, quartz, glass beads, glass spheres, diamond particles, hard plastics, reinforced polymers and organics, and/or any combination thereof. In a preferred embodiment, the thickness of abrasive layer 103 may be about 0.01-0.25 mm.

In FIG. 1, sanding layer 102 may comprise acrylic lacquer, sanding sealer, particles, and/or any combination thereof. In another embodiment, the sanding layer may comprise aluminum oxide (AlOx), carborundum, quartz, glass beads, glass spheres, diamond particles, hard plastics, reinforced polymers and organics, and/or any combination thereof. In a preferred embodiment, the thickness of sanding layer 102 may be about 0.001-0.050 mm.

In FIG. 1, gloss layer 101 may comprise a UV lacquer. For example, the UV lacquer may comprise a two-component system, an epoxy amine, a polyurethane iscocyante, an isocyanate alcohol, or an acid alcohol system, a water-based two-component system, and/or any combination thereof. In a preferred embodiment, the thickness of gloss layer 101 may be about 0.01-0.25 mm. In a preferred embodiment, the gloss level of the composite polymer flooring tile may be at least 90% at 60° based on the American Society for Testing and Materials (ASTM) D523 and EN 16094 testing methods. In another preferred embodiment, the composite polymer flooring tile may meet European Producers of Laminate Flooring (EPLF) abrasion criteria (“AC”) rating of AC3, AC4, AC5, and/or AC6.

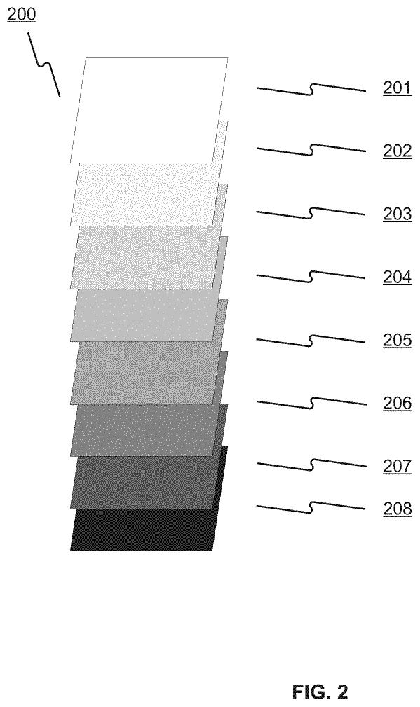

FIG. 2 shows a schematic diagram of an embodiment of a high gloss polymer hard flooring tile 200 with a cushion layer. Optionally, a cushioning layer 208 of variable thickness may be provided. A core layer 207 of variable thickness may be applied on the top surface of cushion layer 208. A print layer 206 of variable thickness may be applied on the top surface of core layer 207 by hot lamination. Optionally, a wear layer 205 of variable thickness may be applied on the top surface of print layer 206 by hot lamination. Optionally, a primer layer 204 of variable thickness may be applied on the top surface of wear layer 205 by a coating device. Optionally, an abrasive layer 203 of variable thickness may be applied on the top surface of primer layer 204 by a coating device. Optionally, a sanding layer 202 of variable thickness may be applied to the top surface of the abrasive layer 203 by curing in a closed environment. A gloss layer 201 of variable thickness may be applied on the top surface of the sanding layer 202 by UV curing.

In FIG. 1, an embodiment of a high gloss polymer hard flooring tile 100 may meet requirements of abrasion resistance, impact resistance, and resistance to effects of heat and discoloration. An embodiment of a high gloss polymer hard flooring tile 100 in FIG. 1 may meet an Impact Insulation Class (IIC) rating between 50 and above.

In FIG. 2, cushioning layer 208 may comprise ethylene-vinyl acetate (EVA), irradiation cross-linked polyethylene (IXPE), cork, any vinyl sheet, and/or any combination thereof. In a preferred embodiment, the thickness of cushioning layer 208 may be about 0.50-2.00 mm.

In FIG. 2, core layer 207 may comprise a thermoplastic material and fillers, or any other type of polymer core comprising fillers and a thermoplastic material. For example, the thermoplastic material may comprise polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, methacrylate, high density polyethylene (HDPE), low density polyethylene (LDPE), and/or any combination thereof. Further, for example, the fillers may comprise calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, internal lubricants and/or a combination thereof. In a preferred embodiment, the thickness of core layer 207 may be about 1.00-8.00 mm.

In FIG. 2, print layer 206 may comprise a thermoplastic material. For example, the thermoplastic material may comprise polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, methacrylate, high density polyethylene (HDPE), low density polyethylene (LDPE), and/or any combination thereof. The print layer may include a decorative design. In a preferred embodiment, the thickness of print layer 206 may be about 0.07-0.01 mm.

In FIG. 2, wear layer 205 may comprise a thermoplastic material and a filler, plasticizer, and/or a combination thereof. For example, the thermoplastic material may comprise polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, methacrylate, high density polyethylene (HDPE), low density polyethylene (LDPE), and/or any combination thereof. Further, for example, the filler may comprise calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, internal lubricants, and/or any combination thereof. Moreover, for example, the plasticizer may comprise phthalate based or phthalate-free plasticizers and/or any combination thereof. For example, the phthalate based plasticizer may comprise phthalic acid esters such as di-(2-ethylhexyl) phthalate, diisononyl phthalate, dibutyl phthalate, diisodecyl phthalate, di-n-octyl phthalate, benzyl butyl phthalate, isophthalic acid, terephthalic acid, and/or any combination thereof. For example, the phthalate-free plasticizers may comprise alkyl esters of cyclohexane dicarboxylic acids, the dialkyl esters of aliphatic dicarboxylic acids, the alkyl esters of aromatic di-, tri-, or tetra-carboxylic acids, except for orthophthalic acid, benzoates, citrates, phosphates, sulfonates, and/or any combination thereof. In a preferred embodiment, the thickness of wear layer 5 may be about 0.10-0.70 mm.

In FIG. 2, primer layer 204 may comprise acrylic lacquer. The acrylic lacquer may comprise a thermoplastic material such as a UV curing acrylic based coating. In a preferred embodiment, the thickness of primer layer 204 may be about 0.001-0.050 mm.

In FIG. 2, abrasive layer 203 may comprise acrylic lacquer and wear resistant particles. For example, the acrylic lacquer may comprise a thermoplastic material such as a UV curing acrylic based coating. Further, for example, the wear resistant particles may comprise aluminum oxide, (AlOx), carborundum, quartz, glass beads, glass spheres, diamond particles, hard plastics, reinforced polymers and organics, and/or any combination thereof. In a preferred embodiment, the thickness of abrasive layer 203 may be about 0.01-0.25 mm.

In FIG. 2, sanding layer 202 may comprise acrylic lacquer or sanding sealer, particles, and/or any combination thereof. In another embodiment, the sanding layer may comprise aluminum oxide (AlOx), carborundum, quartz, glass beads, glass spheres, diamond particles, hard plastics, reinforced polymers and organics, and/or any combination thereof. In a preferred embodiment, the thickness of sanding layer 202 may be about 0.001-0.050 mm.

In FIG. 2, gloss layer 201 may comprise UV lacquer. For example, the UV lacquer may comprise a two-component system, an epoxy amine, a polyurethane iscocyante, an isocyanate alcohol, or an acid alcohol system, a water-based two-component system, and/or any combination thereof. In a preferred embodiment, the thickness of gloss layer 201 may be between about 0.01-0.25 mm. In a preferred embodiment, the gloss level of the composite polymer flooring tile may be at least 85% at 60° based on the ASTM D523 and EN 16094 testing standards. In another preferred embodiment, the composite polymer flooring tile may meet European Producers of Laminate Flooring (EPLF) abrasion criteria (“AC”) rating of AC3, AC4, AC5, and/or AC6. The AC6 rating may be based on the EN 13329 testing standard.

In FIG. 2, an embodiment of a high gloss polymer hard flooring tile 200 may meet requirements of abrasion resistance, impact resistance, and resistance to effects of heat and discoloration. An embodiment of a high gloss polymer hard flooring tile 200 in FIG. 2 may meet an Impact Insulation Class (IIC) rating between 50 and above.

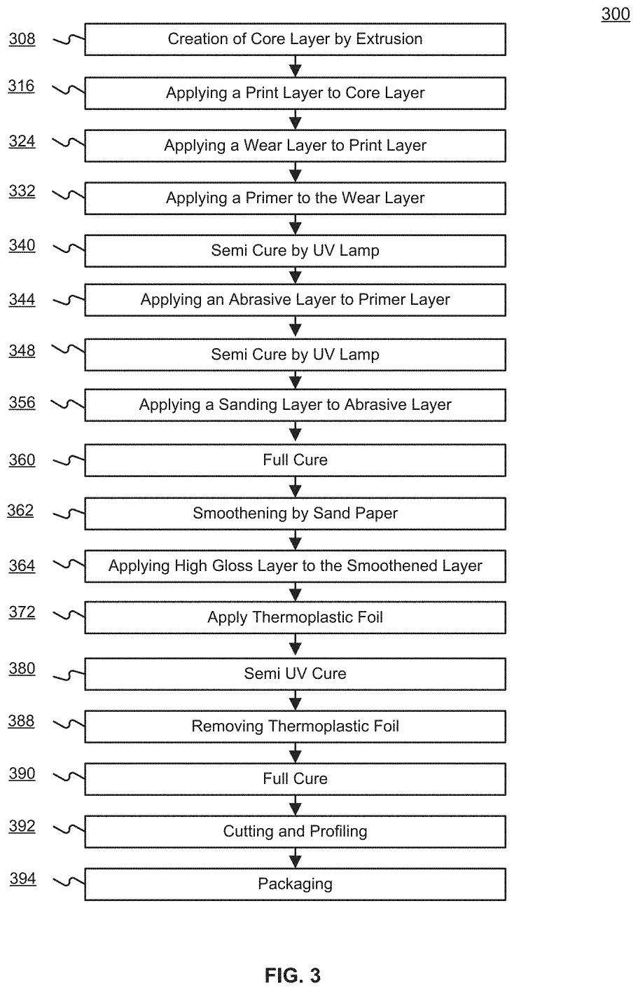

FIG. 3 shows a flow diagram illustrating an example method 300 for manufacturing a flooring tile 100. In one embodiment, method 300 starts with step 308, in which a core layer 107 may be produced by extrusion through an extruder having variable thickness. In FIG. 3, core layer 107 may be produced by extrusion using a T mold with an extruder. The extruder may be conical, parallel counter rotating and/or co-rotating or any combination thereof.

In step 316, print layer 106 of variable thickness may be applied to the top surface of core layer 107 by passing through a hot roller and mechanically hot pressing on the top surface of core layer 107.

In step 324, a wear layer 105 of variable thickness may be applied to the top surface of print layer 106 by passing through a hot roller and mechanically hot pressing on the top surface of print layer 106. In FIG. 3, print layer 106 and wear layer 105 may be applied using hot press or hot rollers and/or any combination thereof.

In step 332, a primer layer 104 of variable thickness may be applied to the top surface of wear layer 105 by passing through a UV light chamber on the top surface of wear layer 105.

In step 340, the primer layer 104 may be subjected to a semi-curing by UV lamp.

In step 344, an abrasive layer 103 of variable thickness may be applied to the top surface of primer layer 104 by passing through a hot roller and mechanically hot pressing on the top surface of primer layer 104.

In step 348, the abrasive layer 103 may be subjected to a semi-curing by UV lamp.

In step 356, a sanding layer 102 of variable thickness may be applied to the top surface of abrasive layer 103 by passing through a UV Light pressing on the top surface of abrasive layer 103. The sanding layer 102 may be smoothened with sand blasting or any other abrasive blasting technique such as blasting the sanding layer 102 with a stream of abrasive materials under high pressure.

In step 360, the sanding layer 102 may be subjected to full curing by UV lamp. In step 362, the sanding layer 102 may be subjected to smoothening by sand paper after the full curing by UV lamp in step 360.

In step 364, a high gloss layer 101 of variable thickness may be applied to the top surface of smoothened sanding layer 102 by passing through a UV Light pressing on the top surface of sanding layer 102.

In step 372, a thermoplastic foil may be applied on the top surface of high gloss layer 101 by passing through a UV Light. For example, the thermoplastic foil may be polyethylene terephthalate (PET), polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, methacrylate, and/or any combination thereof.

In step 380, the high gloss layer 101 may be subjected to semi UV curing. UV cure may occur by use of a UV lamp in order to achieve high gloss. UV radiation curing is a well-known technique and is used in a large variety of applications such as inks, adhesives and coatings. UV curing as a technique for polyvinyl chloride (PVC) floor tiles has been used to improve the quality of PVC floor tiles. UV curing occurs via the polymerization and cross-linking of functional monomers and oligomers into a cross-linked polymer network.

In step 388, the thermoplastic foil on the high gloss layer 101 may be peeled off. For example, the thermoplastic foil may be polyethylene terephthalate (PET), polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, methacrylate, and/or any combination thereof.

In step 390, gloss layer 101 may undergo full UV cure.

In step 392, the high gloss polymer hard flooring tile 100 may undergo cutting and profiling in step 392.

In FIG. 3. the high gloss polymer hard flooring tile 100 may undergo packaging in step 394. It is to be understood that persons of ordinary skill in the art possess the skill to balancing properties such as flexibility, adhesion, abrasion resistance, resistance to discoloration, chemical and stain resistance while curing UV-curable coatings. In a preferred embodiment, acrylated polyurethanes may be utilized for abrasion resistance for PVC floor tiles.

In a preferred embodiment, the gloss level of the composite polymer flooring tile may be at least 75 to 98% at 60° based on the ASTM D523 and EN 16094 testing standards. In another preferred embodiment, the composite polymer flooring tile may meet European Producers of Laminate Flooring (EPLF) abrasion criteria (“AC”) rating of AC3, AC4, AC5, and/or AC6. The AC6 rating may be based on the EN 13329 testing standard.

In FIG. 3, an embodiment of a high gloss polymer hard flooring tile 100 may meet requirements of abrasion resistance, impact resistance, and resistance to effects of heat and discoloration. An embodiment of a high gloss polymer hard flooring tile 100 in FIG. 3 may meet an Impact Insulation Class (IIC) rating between 50 and 62.

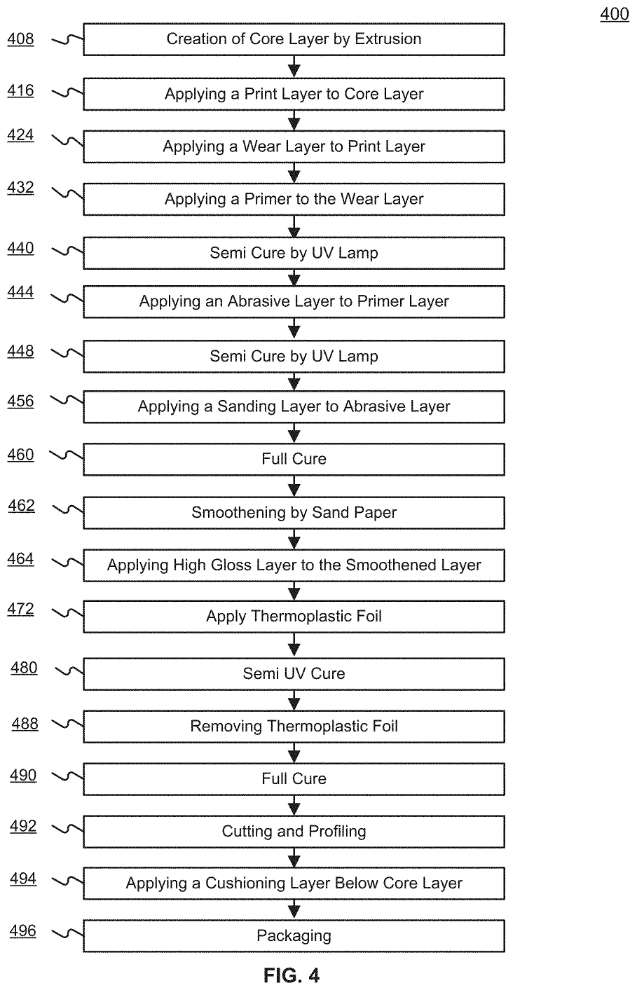

FIG. 4 shows a flow diagram illustrating an example method 400 for manufacturing a flooring tile 200 with a cushioning layer. In a preferred embodiment, method 400 starts with step 408 where a core layer 207 may be produced by extrusion through an extruder having variable thickness. In FIG. 4, core layer 207 may be produced by extrusion using a T mold with an extruder. The extruder may be conical, parallel counter rotating and/or co-rotating or any combination thereof.

In step 416, print layer 206 of variable thickness may be applied to the top surface of core layer 207 by passing through a hot roller and mechanically hot pressing on the top surface of core layer 207. In step 424, a wear layer 205 of variable thickness may be applied to the top surface of print layer 206 by passing through a hot roller and mechanically hot pressing on the top surface of print layer 206. In FIG. 4, print layer 206 and wear layer 205 may be applied using hot press or hot rollers and/or any combination thereof.

In step 432, a primer layer 204 of variable thickness may be applied to the top surface of wear layer 205 by passing through a UV light chamber on the top surface of wear layer 205.

In step 440, the primer layer 204 may be subjected to a semi-curing by UV lamp.

In step 444, an abrasive layer 203 of variable thickness may be applied to the top surface of primer layer 204 by passing through a hot roller and mechanically hot pressing on the top surface of primer layer 204.

In step 448, the abrasive layer 203 may be subjected to a semi-curing by UV lamp.

In step 456, a sanding layer 202 of variable thickness may be applied to the top surface of abrasive layer 203 by passing through a UV Light pressing on the top surface of abrasive layer 203. The sanding layer 202 may be smoothened with sand blasting or any other abrasive blasting technique such as blasting the sanding layer 202 with a stream of abrasive materials under high pressure.

In step 460, the sanding layer 202 may be subjected to full curing by UV lamp.

In step 462, the sanding layer 202 may be subjected to smoothening by sand paper after the full curing by UV lamp in step 460.

In step 464, a high gloss layer 201 of variable thickness may be applied to the top surface of the smoothened sanding layer 202 by passing through a UV Light pressing on the top surface of sanding layer 202.

In step 472, a thermoplastic foil may be applied on the top surface of high gloss layer 201 by passing through a UV Light. For example, the thermoplastic foil may be polyethylene terephthalate (PET), polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, methacrylate, and/or any combination thereof.

In step 480, the high gloss layer 201 may be subjected to semi UV curing. UV cure may occur by use of a UV lamp in order to achieve high gloss. UV radiation curing is a well-known technique and is used in a large variety of applications such as inks, adhesives and coatings. UV curing as a technique for polyvinyl chloride (PVC) floor tiles has been used to improve the quality of PVC floor tiles. UV curing occurs via the polymerization and cross-linking of functional monomers and oligomers into a cross-linked polymer network.

In step 488, the thermoplastic foil on the high gloss layer 201 may be peeled off. For example, the thermoplastic foil may be polyethylene terephthalate (PET), polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, methacrylate, and/or any combination thereof.

In step 490, gloss layer 201 may undergo full UV cure.

In step 492, the high gloss polymer hard flooring tile 200 may undergo cutting and profiling in step 392.

In step 494, a cushioning layer 208 of variable thickness may be applied on the bottom surface of core layer 207. In FIG. 4, cushioning layer 208 may be applied to core layer 207 by hot rolling with a hot melt adhesive.

In FIG. 4. the high gloss polymer hard flooring tile 200 may undergo packaging in step 496.

UV cure may occur by use of a UV lamp in order to achieve high gloss. In a preferred embodiment, the gloss level of the composite polymer flooring tile may be at least 90% at 60° based on the ASTM 523 and EN 16094 testing methods. In another preferred embodiment, the composite polymer flooring tile may meet European Producers of Laminate Flooring (EPLF) abrasion criteria (“AC”) rating of AC3, AC4, AC5, and/or AC6. The AC6 rating may be based on the EN 13329 testing standard.

In FIG. 4, an embodiment of a high gloss polymer hard flooring tile 200 may meet requirements of abrasion resistance, impact resistance, and resistance to effects of heat and discoloration. An embodiment of a high gloss polymer hard flooring tile 200 in FIG. 4 may meet an Impact Insulation Class (IIC) rating between 50 and 62.

The high gloss levels of the flooring tiles described in the present disclosure are desirable because they provide aesthetic value and also create flooring tiles that have excellent hardness, and gloss, making them more durable and less susceptible to wearing down after being subject to prolonged use.

Additional embodiments are contemplated within the scope of this disclosure, including:
1. A composite polymer flooring tile, comprising:
   a core layer;
   a print layer applied to a surface of the core layer, the print layer including a decorative design;
   a wear layer applied to a surface of the print layer;
   a primer layer applied to a surface of the wear layer;
   an abrasive layer applied to the primer layer, the abrasive layer including wear resistant particles
   a sanding layer applied to a surface of the abrasive layer, wherein the sanding layer includes a surface smoothened by sandblasting; and
   a gloss layer applied to a surface of the sanding layer;
   wherein a gloss level of the tile is at least 75% to 98% at 60° as measured according to ASTM D523; and
   wherein the tile meets EPLF abrasion criteria (“AC”) rating of at least AC3 to AC6 in Class 21 to 23 and 31 to 34.
2. The tile of embodiment 1, further comprising:
   a cushioning layer, wherein the core layer is applied to a surface of the cushioning layer.
3. The tile of embodiment 2, wherein the cushioning layer comprises at least one of ethylene-vinyl acetate (EVA), irradiation cross-linked polyethylene (IXPE), or cork or any vinyl sheet.
4. The tile of embodiment 2, wherein the cushioning layer has a thickness between 0.50-2.00 mm.
5. The tile of embodiment 1, wherein the core layer comprises a thermoplastic material and a filler.
6. The tile of embodiment 5, wherein the thermoplastic material comprised in the core layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate, high density polyethylene (HDPE), low density polyethylene (LDPE).
7. The tile of embodiment 5, wherein the filler comprised in the core layer comprises at least one of calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, or internal lubricants.
8. The tile of embodiment 1, wherein the core layer has a thickness between 1.00-8.00 mm.
9. The tile of embodiment 1, wherein the print layer comprises a thermoplastic material.
10. The tile of embodiment 9, wherein the thermoplastic material comprised in the print layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate, high density polyethylene (HDPE), low density polyethylene (LDPE).
11. The tile of embodiment 1, wherein the print layer has a thickness between 0.07-0.10 mm.
12. The tile of embodiment 1, wherein the wear layer comprises a thermoplastic material, a filler, and a plasticizer.
13. The tile of embodiment 12, wherein the thermoplastic material comprised in the wear layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate, high density polyethylene (HDPE), low density polyethylene (LDPE).
14. The tile of embodiment 12, wherein filler comprised in the wear layer comprises at least one of calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, or internal lubricants.
15. The tile of embodiment 12, wherein the plasticizer comprised in the wear layer comprises at least one of di-(2-ethylhexyl) phthalate, diisononyl phthalate, dibutyl phthalate, diisodecyl phthalate, di-n-octyl phthalate, benzyl butyl phthalate, isophthalic acid, terephthalic acid, alkyl esters of cyclohexane dicarboxylic acids, the dialkyl esters of aliphatic dicarboxylic acids, the alkyl esters of aromatic di-, tri-, or tetra-carboxylic acids, benzoates, citrates, phosphates, or sulfonates.
16. The tile of embodiment 1, wherein the wear layer has a thickness between 0.10-0.70 mm.
17. The tile of embodiment 1, wherein the primer layer comprises an acrylic lacquer.
18. The tile of embodiment 17, wherein the acrylic lacquer comprised in the primer layer comprises a thermoplastic material.
19. The tile of embodiment 18, wherein the thermoplastic material comprised in the primer layer comprises a UV curing acrylic based coating.
20. The tile of embodiment 1, wherein the primer layer has a thickness between 0.001-0.050 mm.
21. The tile of embodiment 1, wherein the sanding layer comprises an acrylic lacquer, sanding sealer, and particles.
22. The tile of embodiment 21, wherein the acrylic lacquer comprised in the sanding layer comprises a thermoplastic material.
23. The tile of embodiment 21, wherein the particles comprised in the sanding layer comprises at least one of aluminum oxide (AlOx), carborundum, quartz, glass beads, glass spheres, diamond particles, hard plastics, reinforced polymers, or organic particles.
24. The tile of embodiment 1, wherein the sanding layer has a thickness between 0.001-0.050 mm.
25. The tile of embodiment 1, wherein the abrasive layer comprises an acrylic lacquer.
26. The tile of embodiment 25, wherein the acrylic lacquer comprised in the abrasive layer comprises a thermoplastic material.
27. The tile of embodiment 26, wherein the thermoplastic material comprised in the acrylic lacquer comprises a UV curing acrylic based coating.
28. The tile of embodiment 1, wherein the wear resistant particles included in the abrasive layer comprise at least one of aluminum oxide (AlOx), carborundum, quartz, glass beads, glass spheres, diamond particles, hard plastics, reinforced polymers, or organic particles.
29. The tile of embodiment 1, wherein the abrasive layer has a thickness between 0.01-0.25 mm.
30. The tile of embodiment 1, wherein the gloss layer comprises a UV lacquer.
31. The tile of embodiment 30, wherein the UV lacquer comprised in the gloss layer comprises at least one of a two-component system, an epoxy amine, a polyurethane iscocyante, an isocyanate alcohol, an acid alcohol system, or a water-based two-component system.
32. The tile of embodiment 1, wherein the gloss layer has a thickness between 0.01-0.25 mm.
33. The tile of embodiment 1, wherein the tile meets EPLF AC rating of at least AC4.
34. The tile of embodiment 33, wherein the tile meets EPLF AC rating of at least AC5.
35. The tile of embodiment 34, wherein the tile meets EPLF AC rating of at least AC6.
36. A composite polymer flooring tile, comprising:
   a core layer;
   a print layer applied to a surface of the core layer, the print layer including a decorative design;
   a wear layer applied to a surface of the print layer;
   a primer layer applied to a surface of the wear layer;
   an abrasive layer applied to a surface of the primer layer,
   a sanding layer applied to the surface of the abrasive layer wherein the sanding layer includes a surface smoothened by sandblasting;
   wherein a gloss level of the tile is at least 90% at 60° as measured according to ASTM D523 and EN 16094 testing methods, and
   wherein the tile meets EPLF abrasion criteria (“AC”) rating of at least AC3.
37. The tile of embodiment 36, further comprising:
   a cushioning layer, wherein the core layer is applied to a surface of the cushioning layer.
38. The tile of embodiment 37, wherein the cushioning layer comprises at least one of ethylene-vinyl acetate (EVA), irradiation cross-linked polyethylene (IXPE), or cork.
39. The tile of embodiment 36, wherein the core layer comprises a thermoplastic material and a filler.
40. The tile of embodiment 39, wherein the thermoplastic material comprised in the core layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate.
41. The tile of embodiment 39, wherein the filler comprised in the core layer comprises at least one of calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, or internal lubricants.
42. The tile of embodiment 36, wherein the core layer has a thickness between 1.00-8.00 mm.
43. The tile of embodiment 36, wherein the print layer comprises a thermoplastic material.
44. The tile of embodiment 43, wherein the thermoplastic material comprised in the print layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate.
45. The tile of embodiment 36, wherein the print layer has a thickness between 0.07-0.01 mm.
46. The tile of embodiment 36, wherein the wear layer comprises a thermoplastic material, a filler, and a plasticizer.
47. The tile of embodiment 46, wherein the thermoplastic material comprised in the wear layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate.
48. The tile of embodiment 46, wherein filler comprised in the wear layer comprises at least one of calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, or internal lubricants.
49. The tile of embodiment 46, wherein the plasticizer comprised in the wear layer comprises at least one of di-(2-ethylhexyl) phthalate, diisononyl phthalate, dibutyl phthalate, diisodecyl phthalate, di-n-octyl phthalate, benzyl butyl phthalate, isophthalic acid, terephthalic acid, alkyl esters of cyclohexane dicarboxylic acids, the dialkyl esters of aliphatic dicarboxylic acids, the alkyl esters of aromatic di-, tri-, or tetra-carboxylic acids, benzoates, citrates, phosphates, or sulfonates.
50. The tile of embodiment 36, wherein the wear layer has a thickness between 0.10-0.70 mm.
51. The tile of embodiment 36, wherein the primer layer comprises an acrylic lacquer.
52. The tile of embodiment 51, wherein the acrylic lacquer comprised in the primer layer comprises a thermoplastic material.
53. The tile of embodiment 52, wherein the thermoplastic material comprised in the primer layer comprises a UV curing poly urethane coating.
54. The tile of embodiment 36, wherein the primer layer has a thickness between 0.001-0.050 mm.
55. The tile of embodiment 36, wherein the sanding layer comprises an acrylic lacquer, sanding sealer, and particles.
56. The tile of embodiment 55, wherein the acrylic lacquer comprised in the sanding layer comprises a thermoplastic material.
57. The tile of embodiment 55, wherein the particles comprised in the sanding layer comprises at least one of aluminum oxide (AlOx), carborundum, quartz, glass beads, glass spheres, diamond particles, hard plastics, reinforced polymers, or organic particles.
58. The tile of embodiment 36, wherein the sanding layer has a thickness between 0.001-0.050 mm.
59. The tile of embodiment 36, further comprising:
   an abrasive layer applied to the smoothened surface of the primer layer; and
   wherein the abrasive layer comprises an acrylic lacquer and wear resistant particles.
60. The tile of embodiment 59, wherein the acrylic lacquer comprised in the abrasive layer comprises a thermoplastic material.
61. The tile of embodiment 60, wherein the thermoplastic material comprised in the acrylic lacquer comprises a UV curing poly urethane coating.
62. The tile of embodiment 59, wherein the wear resistant particles comprised in the abrasive layer comprise at least one of aluminum oxide (AlOx), carborundum, quartz, glass beads, glass spheres, diamond particles, hard plastics, reinforced polymers, or organic particles.
63. The tile of embodiment 59, wherein the abrasive layer has a thickness between 0.01-0.25 mm.
64. The tile of embodiment 59, further comprising:
   a gloss layer applied to a surface of the sanding layer;
   wherein the gloss layer comprises a UV lacquer.
65. The tile of embodiment 64, wherein the UV lacquer comprised in the gloss layer comprises at least one of a two-component system, an epoxy amine, a polyurethane iscocyante, an isocyanate alcohol, an acid alcohol system, or a water-based two-component system.
66. The tile of embodiment 64, wherein the gloss layer has a thickness between 0.01-0.25 mm.
67. The tile of embodiment 36, wherein the tile meets EPLF AC rating of at least AC4.
68. The tile of embodiment 67, wherein the tile meets EPLF AC rating of at least AC5.
69. The tile of embodiment 68, wherein the tile meets EPLF AC rating of at least AC6.
70. A method for manufacturing a composite polymer flooring tile, comprising:
   creating a core layer,
   applying a cushioning layer below the core layer,
   applying a print layer to the core layer,
   applying a wear layer to the print layer,
   applying a primer layer to the wear layer,
   semi-curing the primer layer by UV lamp,
   applying an abrasive layer to the primer layer,
   semi-curing the abrasive layer by UV lamp,
   applying a sanding layer to the abrasive layer,
   smoothing the sanding layer by sand blasting,
   curing the sanding layer by UV cure,
   applying a gloss layer to the sanding layer,
   applying a thermoplastic foil to the gloss layer,
   curing the gloss layer by UV cure.
71. The method of embodiment 70, wherein the core layer is produced by extrusion using a T mold with a conical extruder.
72. The method of embodiment 71, wherein the extruder used to produce the core layer comprises a conical, parallel counter rotating, or co-rotating extruder.
73. The method of embodiment 70, wherein the cushioning layer is applied to the core layer by hot rolling with a hot melt adhesive.
74. The method of embodiment 70, wherein the print layer is applied to the core layer by a method of pressing.
75. The method of embodiment 74, wherein the method of pressing comprises pressing using hot rollers of a hot press.
76. The method of embodiment 70, wherein the wear layer is applied to the print layer by a method of pressing.
77. The method of embodiment 76, wherein the method of pressing comprises pressing using hot rollers of a hot press.
78. The method of embodiment 70, wherein the sanding layer is smoothened by an abrasive blasting technique.
79. The method of embodiment 78, wherein the abrasive blasting technique comprises sand blasting the sanding layer with a stream of abrasive materials under high pressure.
80. The method of embodiment 70, wherein the gloss layer is cured by applying a thermoplastic foil on a top surface of the gloss layer in a closed environment.
81. The method of embodiment 80, wherein the thermoplastic foil for curing the gloss layer is comprised of at least one of polyethylene terephthalate (PET), polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate.
82. The method of embodiment 70, further comprising:
   de-touching the cure on the gloss layer by removing the thermoplastic foil from the gloss layer.
83. The method of embodiment 70, wherein the primer layer is applied to the wear layer by passing through a UV light chamber.
84. The tile of embodiment 1, wherein the tile has an Impact Insulation Class (IIC) rating between 50 and 62.
85. The tile of embodiment 36, wherein the tile has an Impact Insulation Class (IIC) rating between 50 and 62.
86. The method of embodiment 70, wherein the sanding layer undergoes smoothening by sand paper after undergoing full cure.
87. The method of embodiment 70, wherein the composite polymer flooring tile undergoes cutting and profiling.
88. The method of embodiment 70, wherein the composite polymer flooring tile undergoes packaging after cutting and profiling.
89. The method of embodiment 70, wherein the sanding layer is smoothened by sandpaper.

The specification has described high gloss polymer flooring tiles and methods for manufacturing the same. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It is intended that the disclosure and examples be considered as exemplary only, with a true scope and spirit of disclosed embodiments being indicated by the following claims.

1. A composite polymer flooring tile, comprising:
a core layer;
a print layer applied to a surface of the core layer, the print layer including a decorative design;
a wear layer applied to a surface of the print layer;
a primer layer applied to a surface of the wear layer;
an abrasive layer applied to a surface of the primer layer,
a sanding layer applied to the surface of the abrasive layer wherein the sanding layer includes a surface smoothened by sandblasting;
wherein a gloss level of the tile is at least 90% at 60° as measured according to ASTM D523 and EN 16094 testing methods, and
wherein the tile meets EPLF abrasion criteria (“AC”) rating of at least AC3.

2. The tile of claim 1, further comprising:
a cushioning layer, wherein the core layer is applied to a surface of the cushioning layer.

3. The tile of claim 2, wherein the cushioning layer comprises at least one of ethylene-vinyl acetate (EVA), irradiation cross-linked polyethylene (IXPE), or cork.

4. The tile of claim 1, wherein the core layer comprises a thermoplastic material and a filler.

5. The tile of claim 4, wherein the thermoplastic material comprised in the core layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate.

6. The tile of claim 4, wherein the filler comprised in the core layer comprises at least one of calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, or internal lubricants.

7. The tile of claim 1, wherein the core layer has a thickness between 1.00-8.00 mm.

8. The tile of claim 1, wherein the print layer comprises a thermoplastic material.

9. The tile of claim 8, wherein the thermoplastic material comprised in the print layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate.

10. The tile of claim 1, wherein the print layer has a thickness between 0.07-0.01 mm.

11. The tile of claim 1, wherein the wear layer comprises a thermoplastic material, a filler, and a plasticizer.

12. The tile of claim 11, wherein the thermoplastic material comprised in the wear layer comprises at least one of polyvinyl chloride (PVC), polyurethane (PU), polyethylene terephthalate (PET), polyvinyl butyral (PVB), polybutylene terephthalate (PBT), cross-linked polyethylene (PEX), polyethylene (PE), polyester, polystyrene (PS), polypropylene (PP), polycarbonate (PC), polyvinyl acetate (PVAc), ethylene-vinyl acetate (EVA), polyacrylate, or methacrylate.

13. The tile of claim 11, wherein the filler comprised in the wear layer comprises at least one of calcium carbonate, clays, calcium silicate, talc, calcium sulfate, calcium oxide, magnesium oxide, titanium oxide, zinc oxide, alumino-silicates, dolomite, bauxite, silica, diotamaceous earth, molecular sieves, fly ash, limestone, heat stabilizer additives, external lubricants, or internal lubricants.

14. The tile of claim 11, wherein the plasticizer comprised in the wear layer comprises at least one of di-(2-ethylhexyl) phthalate, diisononyl phthalate, dibutyl phthalate, diisodecyl phthalate, di-n-octyl phthalate, benzyl butyl phthalate, isophthalic acid, terephthalic acid, alkyl esters of cyclohexane dicarboxylic acids, dialkyl esters of aliphatic dicarboxylic acids, alkyl esters of aromatic di-, tri-, or tetra-carboxylic acids, benzoates, citrates, phosphates, or sulfonates.

15. The tile of claim 1, wherein the wear layer has a thickness between 0.10-0.70 mm.

16. The tile of claim 1, wherein the primer layer comprises an acrylic lacquer, wherein the acrylic lacquer comprises a thermoplastic material.

17. (canceled)

18. The tile of claim 17, wherein the thermoplastic material comprised in the primer layer comprises a UV curing polyurethane coating.

19. The tile of claim 1, wherein the primer layer has a thickness between 0.001-0.050 mm.

20. The tile of claim 1, wherein the sanding layer comprises an acrylic lacquer, sanding sealer, and particles.

21. The tile of claim 20, wherein the acrylic lacquer comprised in the sanding layer comprises a thermoplastic material.

22. The tile of claim 20, wherein the particles comprised in the sanding layer comprise at least one of aluminum oxide (AlOx), carborundum, quartz, glass beads, glass spheres, diamond particles, hard plastics, reinforced polymers, or organic particles.

23. The tile of claim 1, wherein the sanding layer has a thickness between 0.001-0.050 mm.

24. The tile of claim 1, further comprising:
an abrasive layer applied to the smoothened surface of the sanding layer; and
wherein the abrasive layer comprises an acrylic lacquer and wear resistant particles.

25. The tile of claim 24, wherein the acrylic lacquer comprised in the abrasive layer comprises a thermoplastic material, wherein the thermoplastic material comprises a UV curing polyurethane coating.

26. (canceled)

27. The tile of claim 24, wherein the wear resistant particles comprised in the abrasive layer comprise at least one of aluminum oxide (AlOx), carborundum, quartz, glass beads, glass spheres, diamond particles, hard plastics, reinforced polymers, or organic particles.

28. The tile of claim 24, wherein the abrasive layer has a thickness between 0.01-0.25 mm.

29. The tile of claim 24, further comprising:
a gloss layer applied to a surface of the sanding layer;
wherein the gloss layer comprises a UV lacquer.

30. The tile of claim 29, wherein the UV lacquer comprised in the gloss layer comprises at least one of a two-component system, an epoxy amine, a polyurethane iscocyante, an isocyanate alcohol, an acid alcohol system, or a water-based two-component system.

31. The tile of claim 29, wherein the gloss layer has a thickness between 0.01-0.25 mm.

32. The tile of claim 1, wherein the tile meets EPLF AC rating ranging from AC4 to AC6.

33. (canceled)

34. (canceled)
